(19) United States
(12) Patent Application Publication
(10) Pub. No.: US 2007/0034065 A1
(43) Pub. Date: Feb. 15, 2007

(54) Laser marker for circular-saw machine

(75) Inventors: Yen-Chih Chang, Taichung Hsien (TW); Jung-Huo Chen, Taichung Hsien (TW)

Correspondence Address: BACON & THOMAS, PLLC, 625 SLATERS LANE, FOURTH FLOOR, ALEXANDRIA, VA, 22314, US

(73) Assignee: REXON INDUSTRIAL CORPORATION LTD., TAICHUNG HSIEN (TW)

(21) Appl. No.: 11/489,480

(22) Filed: Jul. 20, 2006

(30) Foreign Application Priority Data
Aug. 10, 2005 (TW) 94213648

(51) Int. Cl. B26D 7/00

(52) U.S. Cl. 83/520

(57) ABSTRACT

A laser marker used in a circular-saw machine is disclosed to include a housing mounted on the motor shaft of the motor of the circular-saw machine for rotation with a saw blade, a laser light source mounted inside the housing and aiming an outlet of the housing, and a power adapter electrically connected to the external power supply for driving the motor and the laser light source so as to provide the necessary working power to the laser light source. Therefore, the laser light source emits a laser beam out of the outlet for indication.

### BACKGROUND OF THE INVENTION

1. Field of the Invention

The present invention relates to a circular-saw machine, and more specifically to a laser marker adapted to a circular-saw machine.

2. Description of the Related Art

A conventional laser marker adapted to a circular-saw machine, for example, Taiwan Patent No. M240285, entitled “Laser Positioning Structure for Circular-saw Machine”, is composed of a laser light source, a power supply module (e.g. a battery set) and a power control module (e.g. a switch or a control IC) respectively mounted inside a cover shell. The laser marker emits a laser beam for positioning or indexing. FIG. 5. shows a laser marker used in a circular-saw machine according to Taiwan Patent No. 537,083, entitled “Laser Line-Marking Device for Circular-saw Machine”. According to this design, the laser marker includes a rotary base 71, a cover 72, and a ring magnet holder 73. The rotary base 71 is mounted on a rotatable shaft 74. When a motor 75 drives the rotatable shaft 74 to rotate at a high speed, the rotary base 71 and a ring magnet 76 in the ring magnet holder 73 induce each other to produce a current driving a laser light source 79 in the rotary holder base 71 to emit a laser beam.

The aforesaid conventional designs are still defective in function due to the following drawbacks:

1. It is necessary to replace the power supply device. The power supply module is mounted inside the cover, not electrically connecting to an external power. When the power of the power supply module is used up, the user must open the cover, and replace the power supply module by a new one, and then close the cover. Therefore, the use of the laser light source is inconvenient.

2. The laser marker is subject to malfunction resulted from disengagement of the power supply module. Because the laser light source, the power supply module and the power control module are all mounted inside the cover shell, and the cover shell is rotatable with the saw blade of the circular-saw machine, the elements inside the cover may be vibrated during a high rotational speed operation. Therefore, the power supply module tends to be forced to an unsuitable place, resulting in the malfunction of the laser light source.

3. The structure for produce the induced current with the ring magnet is complicated. When the laser marker fails, it is difficult to fix up the laser marker.

### SUMMARY OF THE INVENTION

The present invention has been accomplished under the circumstances in view. It is therefore one object of the present invention to provide a laser marker, which uses a current from an external AC power supply to drive a laser light source to emit a laser beam, thereby eliminating the problems of the aforesaid prior art.

According to the present invention, the laser marker is installed in a circular-saw machine. The circular-saw machine includes a motor and a saw blade. The motor has a motor shaft. The saw blade is mounted on the motor shaft of the motor for rotation with the motor shaft. The laser marker has a housing, a laser light source and a power adapter. The housing is mounted on the motor shaft of the motor for rotation with the motor shaft. The housing is opened an outlet. The laser light source is mounted inside the housing for emitting a laser beam out of the outlet. The power adapter is electrically connected to an external power supply for driving the motor and the laser light source so as to drive the laser light source to emit a laser beam.

Because the power adapter is not mounted inside the housing, the power adapter does not rotate with the housing and the motor shaft, preventing malfunction of the power adapter under the vibration of the housing during a high rotational speed operation. Further, because the invention uses the current from the external AC power supply to drive the laser light source, the user doesn't need to detach the housing for replacing the battery. Further, the power adapter has a simpler structure, which is cheap and easy to maintain, than the power generator of ring magnet.

### BRIEF DESCRIPTION OF THE DRAWINGS

FIG. 1 is an exploded view of a laser marker according to an embodiment of the present invention.

FIG. 2 is a circuit diagram of the laser marker according to the embodiment of the present invention.

FIG. 3 is a schematic drawing showing the laser marker adapted to a circular-saw machine.

FIG. 4 is a circuit diagram of an AC-to-DC converter circuit according to another embodiment of the present invention.

FIG. 5 is a schematic drawing showing a laser marker installed in a circular-saw machine according to the prior art.

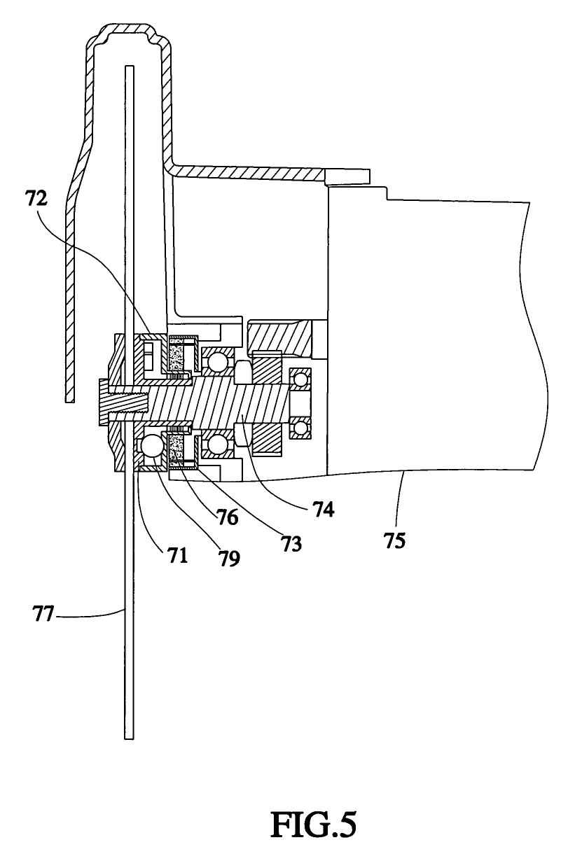

### DETAILED DESCRIPTION OF THE INVENTION

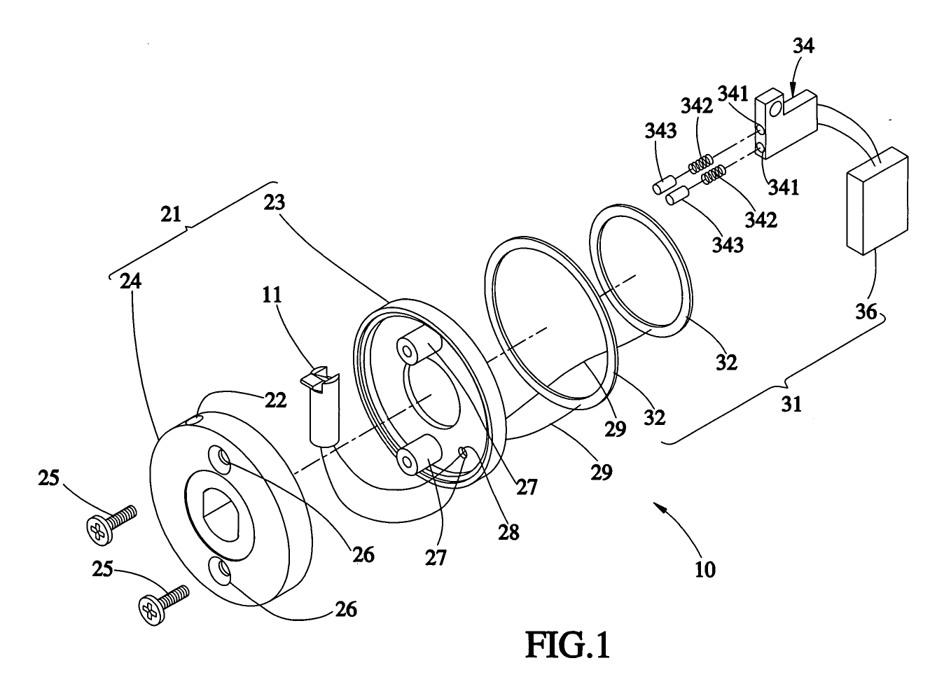

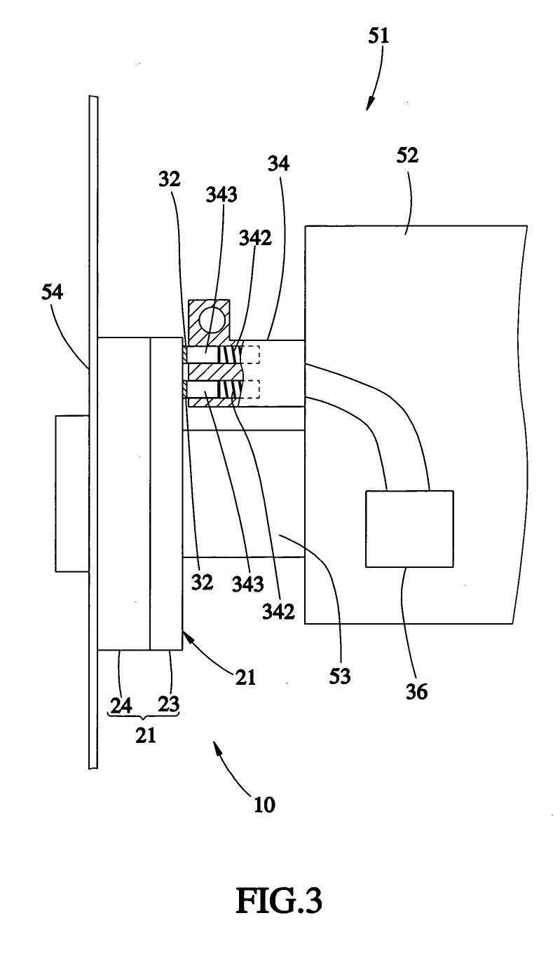

Referring to FIGS. 1-3, a laser marker 10 in accordance with the present invention is shown and installed in a circular-saw machine 51. The circular-saw machine 51 includes a motor 52 and a saw blade 54. The motor 52 has a motor shaft 53. The saw blade 54 is mounted on the motor shaft 53 of the motor 52. The laser marker 10 includes a laser light source 11, a housing 21, and a power adapter 31. The housing 21 has a flat circular shape composed of a right-side shell 23 and a left-side shell 24. The left-side shell 24 is opened an outlet 22 at the periphery thereof. After the right-side shell 23 and the left-side shell 24 are attached together, by means that two screws 25 are respectively screwed into two screw holes 26 of the left-side shell 24 and two stud nuts 27 of the right-side shell 23 to secure the two shells 23, 24 firmly together, the outlet 22 is kept to communicate with the inside space of the housing 21 and the outside space. The laser light source 11 is mounted inside the housing 21 and aligned with the outlet 22. The motor shaft 53 pierces through the housing 21 set between the motor 52 and the saw blade 54. The power adapter 31 has two ring electrodes 32, an electric brush holder 34 and an AC-to-DC converter circuit 36. The two ring electrodes 32 are touched on the outside wall of the right-side shell 23 and spaced from each other at a predetermined distance, for example, over 3 mm. The two ring electrodes 32 are respectively electrically connected to the positive pole and negative pole of the laser light source 11, for example, by means of two wires 29 each running through a hole 28 formed on the right-side shell 23 to connect with the ring electrodes 32 and the laser light source 11. The electric brush holder 34 forms two electrode holes 341, and has two springs 342 and two brush electrodes 343. After the two springs 342 are respectively put into the two electrode holes 341, the two brush electrodes 343 are respectively inserted into the electrode holes 341 and press the two springs 342. In this embodiment, the brush electrodes 343 are carbon rods and respectively disposed to contact with the two ring electrodes 32.

The AC-to-DC converter circuit 343 is electrically connected to the two brush electrodes 343, providing DC current through the brush electrodes 343 and the ring electrodes 32 to the laser light source 11 so as to drive the laser light source 11 to emit a laser beam out of the outlet 22.

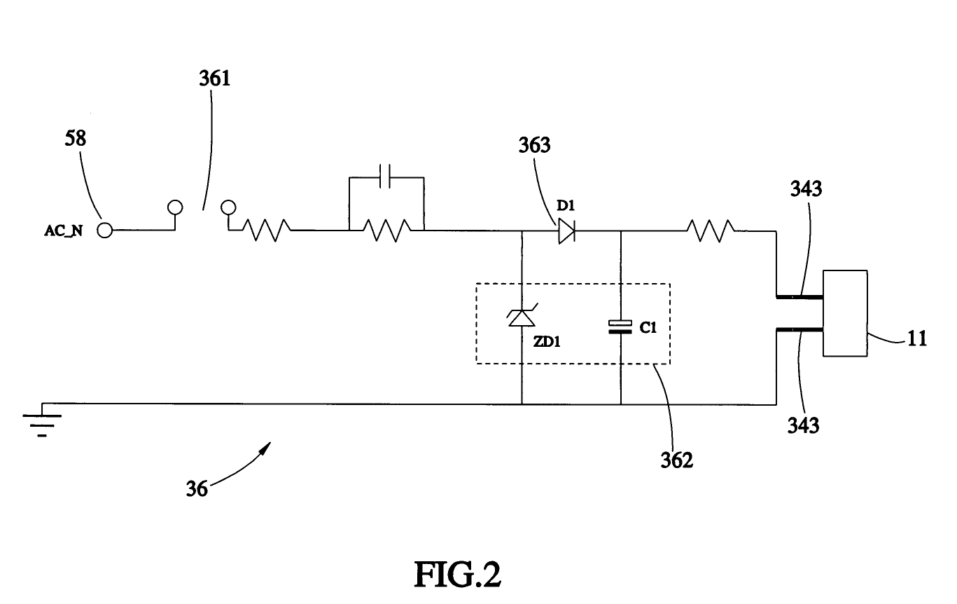

Referring to FIG. 2, the AC-to-DC converter circuit 36 includes a switch 361, a voltage stabilizer circuit 362 and a rectifier circuit 363. The voltage stabilizer circuit 362 includes a Zener diode ZD1 and a discharging capacitor C1 connected in parallel to Zener diode ZD1. Further, the discharging capacitor C1 is connected in parallel to the laser light source 11 through the brush electrodes 343. The voltage stabilizer circuit 362 is electrically connected to an external power supply 58 for driving the motor 52 through the switch 361. The rectifier circuit 363 has a diode D1 electrically connected to the switch 361 and the laser light source 11. Therefore, the AC-to-DC converter circuit 36 is electrically connected to the external power supply 58 for converting the current from the external power supply 58 into a direct current. In this embodiment, the external power supply 58 is an AC power supply.

When in use, the user can operate the switch 361 to turn on/off the laser light source 11. When the switch 361 is short-circuit, the AC-to-DC converter circuit 36 converts the current from the external power supply 58 into the direct current and output it. The direct current, through the brush electrodes 343 and the ring electrodes 32 contacting continuously with the brush electrodes 343 during rotation of the housing 21 with the saw blade 54, is input into the laser light source 11, causing the laser light source 11 to emit a laser beam and thereby generating a belt of light on the workpiece for indication.

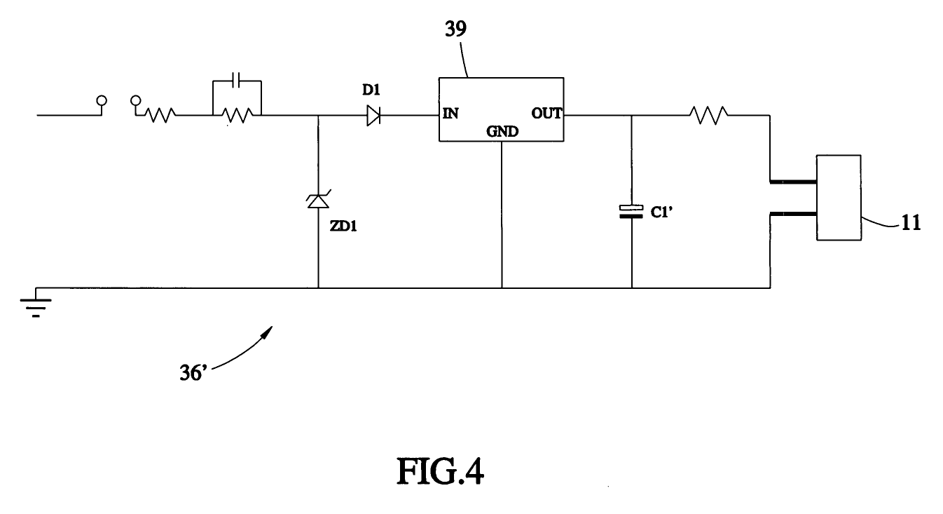

FIG. 4 is a circuit diagram of another embodiment of the present invention. According to this embodiment, the AC-to-DC converter circuit 36′ is substantially the same as the circuit architecture shown in FIG. 2, except a DC voltage stabilizer 39 (e.g. 7805 IC regulator). The DC voltage stabilizer 39 is connected in series between the diode D1 and the laser light source 11 to provide an additional protection on voltage stability.

As stated above, the invention has the following advantages:

1. Easy to operate: Because the invention uses the current from the external AC power supply 58 to drive the laser light source 11, the user doesn't need to detach the housing 21 for replacing the batteries.

2. Durable in use: Because the power adapter 31 is not provided inside the housing 21, the power adapter 31 does not rotate with the housing 21, preventing malfunction of the power adapter 31 under the vibration of the housing 21 during a high speed rotation.

3. Easy for assembly: Because the invention uses the current from the external power supply 58 to drive the laser light source 11, the invention doesn't have a complicated power generator or a battery and the battery's holder means. Therefore, the structure of the invention is easy to be assembled.

Although two particular embodiments of the invention have been described in detail for purposes of illustration, various modifications and enhancements may be made without departing from the spirit and scope of the invention. Accordingly, the invention is not to be limited except as by the appended claims.

What is claimed is:

1. A laser marker for a circular-saw machine, said circular-saw machine having a motor and a saw blade, said motor having a motor shaft, said saw blade mounted on said motor shaft of said motor for rotation with said motor shaft, the laser marker comprising:
a housing mounted on said motor shaft of said motor for rotation with said motor shaft and opened an outlet;
a laser light source disposed inside said housing and emitting a laser beam out of said outlet; and
a power adapter electrically connecting to an external power supply driving said motor and said laser light source for adjusting a current from said external power supply to drive said laser light source to emit said laser beam.

2. The laser marker as claimed in claim 1, wherein said power adapter comprises:
two ring electrodes mounted on an outside wall of said housing and spaced from each other at a predetermined distance and respectively electrically connected to said laser light source; and
an electric brush holder electrically connected to said external power supply and having two brush electrodes respectively disposed to contact said ring electrodes;
thereby said external power supply electrically connected to said laser light source.

3. The laser marker as claimed in claim 2, wherein said external power supply is an AC power supply.

4. The laser marker as claimed in claim 3, wherein said power adapter further comprises an AC-to-DC converter circuit electrically connected to said external power supply and said two brush electrodes of said electric brush holder for converting said current from said external power supply into a direct current.

5. The laser marker as claimed in claim 4, wherein said AC-to-DC converter circuit comprises a switch, a voltage stabilizer circuit, and a rectifier circuit.

6. The laser marker as claimed in claim 5, wherein said voltage stabilizer circuit comprises a Zener diode and a discharging capacitor.

7. The laser marker as claimed in claim 6, wherein said discharging capacitor is connected in parallel to said laser light source.

8. The laser marker as claimed in claim 5, wherein said rectifier circuit comprises a diode.

9. The laser marker as claimed in claim 5, wherein said AC-to-DC converter circuit further comprises a DC voltage stabilizer connected in series to said rectifier circuit for voltage-stabilized protection.

10. The laser marker as claimed in claim 2, wherein said predetermined distance is over 3 mm.

11. The laser marker as claimed in claim 2, wherein said brush electrodes are carbon rods.

12. The laser marker as claimed in claim 2, wherein said electric brush holder comprises two electrode holes, and two springs respectively disposed in said electrode holes for supporting said brush electrodes disposed in said electrode holes and forcing said brush electrodes to be in contact with said ring electrodes respectively.

13. The laser marker as claimed in claim 1, wherein said housing has a flat circular shape.
